(19) United States
(12) Patent Application Publication
(10) Pub. No.: US 2026/0127438 A1
(43) Pub. Date: May 7, 2026

(54) SYSTEM AND METHOD FOR FINE-TUNING ROTATED OUTLIER-FREE LARGE LANGUAGE MODELS FOR EFFECTIVE WEIGHT-ACTIVATION QUANTIZATION

(71) Applicant: The Hong Kong University of Science and Technology, Hong Kong (CN)

(72) Inventors: Xijie HUANG, Hong Kong (CN); Kwang Ting CHENG, Hong Kong (CN); Zechun LIU, Riverside, CA (US); Shih-yang LIU, Hong Kong (CN)

(21) Appl. No.: 19/352,500

(22) Filed: Oct. 8, 2025

Related U.S. Application Data
(60) Provisional application No. 63/717,284, filed on Nov. 7, 2024.

(51) Int. Cl. G06N 3/082

(52) U.S. Cl. CPC G06N 3/082

(57) ABSTRACT

A computing device includes at least one processor, one or more non-transitory computer-readable storage media, a system for fine-tuning a large language model under low-bit weight-activation quantization. The computing device further comprises a graphics processing unit (GPU), a neural processing unit (NPU), or a tensor processing unit (TPU). The hardware interface module of the system is configured to load a low-bit model representation from the memory module and transmit the model representation to the GPU, NPU, or TPU for inference execution.

### CROSS-REFERENCE TO RELEVANT APPLICATIONS

The present application claims priority from a U.S. provisional patent application Ser. No. 63/717,284 filed Nov. 7, 2024, and the disclosure of which are incorporated by reference in their entirety.

### TECHNICAL FIELD

The present invention relates to techniques for model compression and quantization of large-scale neural networks; in particular, to a system and method for fine-tuning rotated outlier-free large language models (LLMs) to facilitate effective weight-activation quantization with improved accuracy and reduced quantization error in low-bit settings.

### BACKGROUND

Large language models (LLMs), such as GPT-4 and LLaMA, have achieved notable success across various tasks. However, the increasing model size and training cost have motivated the development of model compression and parameter-efficient fine-tuning (PEFT) methods. Low-rank adaptation (LoRA) has become a widely adopted PEFT technique for improving fine-tuning efficiency by updating a limited set of parameters.

Recently, quantization techniques, which convert high-precision parameters into lower-bit formats such as INT4, have been integrated with LoRA methods. Existing quantization-LoRA schemes can save memory costs during fine-tuning, and some schemes can also reduce inference costs by producing quantized LLMs directly. However, these methods only perform weight-only quantization, while LoRA weight-activation quantization is under-explored. Quantizing both weights and activations in low-bit further saves run-time GPU memory and accelerates compute-intensive matrix-multiplication operations. It is observed that 4-bit or 6-bit weight-activation quantization with LoRA finetuning still incurs a high accuracy degradation in LLMs, attributing to the outliers in weight and activation distribution, which stretch the quantization range and increase the quantization error.

Existing methods in the post-training quantization research community have endeavored to tackle the outlier challenge by mixed-precision subgrouping or shifting outliers from activation to weight. More recently, applying rotation to the weight matrices of LLMs has demonstrated effectiveness in eliminating activation outliers and keeping computational invariance. However, all these methods solve the problems from a post-training perspective, ignoring that outliers will emerge and change distribution during pre-training and fine-tuning.

Accordingly, there is a need for a system and method that enable effective low-bit weight-activation quantization during fine-tuning of large language models by eliminating outliers in a manner that remains robust throughout the fine-tuning process.

### SUMMARY OF INVENTION

It is an objective of the present invention to provide a system and a method to address the aforementioned shortcomings and unmet needs in the state of the art.

In the present invention, a approach called Rotated outlier-free Low-Rank Adaptation (RoLoRA) is presented, which serves as a LoRA-based scheme for effective weight-activation quantization. RoLoRA utilizes rotation for outlier elimination and proposes rotation-aware fine-tuning to preserve the outlier-free characteristics in rotated LLMs. Experimental results show RoLoRA consistently improves low-bit LoRA convergence and post-training quantization robustness in weightactivation settings. RoLoRA has been evaluated on LLaMA2-7B/13B and LLaMA3-8B models, achieving up to a 29.5% absolute accuracy improvement for 4-bit weight-activation quantized LLaMA2-13B on commonsense reasoning tasks, as compared to the LoRA baseline. The effectiveness of RoLoRA has also been demonstrated on large multimodal models, including LLaVA-1.5-7B.

In accordance with a first aspect of the present invention, a system for fine-tuning a large language model under low-bit weight-activation quantization is provided. The system includes a memory module, a tensor structuring module, a model initialization module, a rotation configuration module, a rotation-aware fine-tuning module, a quantization module, and a hardware interface module. The memory module is configured to store structured representations associated with a model object comprising weight matrices, activation signals, rotation parameters, and intermediate or final representations. The tensor structuring module is configured to receive the structured representations of the model object from the memory module and process the structured representations into structured digital formats suitable for computer processing, in which the structured digital formats are stored in the memory module. The model initialization module is configured to retrieve the structured digital formats from the memory module and modify internal normalization components of the model object to maintain computational invariance during rotation. The rotation configuration module is configured to retrieve the modified model object from the memory module, apply orthogonal rotation transformations to weight matrices and activation signals of the model object, and store the rotated model object in the memory module. The rotation-aware fine-tuning module is configured to retrieve the rotated model object and apply low-rank adaptation according to a selected fine-tuning strategy to the model object, in which the low-rank adaptation comprises inserting and training low-rank matrices while keeping base weights frozen. The quantization module is configured to retrieve the fine-tuned model object and perform quantization of both weights and activations using at least one quantization strategy to generate a low-bit model representation stored in the memory module. The hardware interface module is configured to export the low-bit model representation stored in the memory module to an inference system for deployment.

In accordance with a second aspect of the present invention, a computing device is provided. The computing device includes at least one processor; one or more non-transitory computer-readable storage media; the system as aforementioned; a graphics processing unit (GPU), a neural processing unit (NPU), or a tensor processing unit (TPU). The hardware interface module of the system is configured to load a low-bit model representation from the memory module and transmit the model representation to the GPU, NPU, or TPU for inference execution.

In accordance with a third aspect of the present invention, a method for fine-tuning a large language model under low-bit weight-activation quantization is provided. The method includes steps as follows: receiving, by a tensor structuring module, structured representations associated with a model object comprising weight matrices, activation signals, and rotation parameters; processing the structured representations into structured digital formats suitable for computer processing, by the tensor structuring module, and storing the structured digital formats in a memory module; modifying, by a model initialization module, internal normalization components of the model object to maintain computational invariance during rotation; applying, by a rotation configuration module, orthogonal rotation transformations to weight matrices and activation signals of the model object to produce a rotated model object; applying, by a rotation-aware fine-tuning module, low-rank adaptation to the rotated model object according to a selected fine-tuning strategy, wherein the low-rank adaptation comprises inserting and training low-rank matrices while keeping base weights frozen; performing, by a quantization module, quantization of both weights and activations using at least one quantization strategy to generate a low-bit model representation; and exporting, by a hardware interface module, the low-bit model representation to an inference system for deployment.

By the above configuration, several advantages are achieved, including:
RoLoRA is presented, exploring the feasibility of integrating rotation in LoRA with quantization settings.
RoLoRA enables robust weight-activation quantization of fine-tuned LLMs, especially in low-bit settings such as W4A4 and W6A6.
The effectiveness of RoLoRA on the LLAMA series (2-7B, 2-13B, 3-8B) across quantizers (RTN/GPTQ), bitwidth (W4A4/W6A6), and benchmarks (Zero-shot commonsense, MMLU) has been verified. The applicability of RoLoRA to LMMs has also been demonstrated.

### BRIEF DESCRIPTION OF DRAWINGS

Embodiments of the invention are described in more details hereinafter with reference to the drawings, in which:

FIG. 1 shows activation distribution before and after rotation;

FIG. 2 demonstrates Table 1 for comparing visual instruction outputs generated by different models;

FIG. 3 shows overview of the proposed approach of RoLoRA according to one embodiment of the present invention;

FIG. 4 shows two schemes for performing rotation-aware fine-tuning: (a) LAR; and (b) LBR;

FIG. 5 demonstrates SVD approximation error of optimization targets with different LoRA-rotation integration schemes;

FIG. 6 shows a visualization of activation kurtosis and quantization error, including the training dynamics of activation kurtosis and the quantization error after fine-tuning, comparing LoRA and RoLoRA;

FIG. 7 demonstrates Table 2 for showing comparison of the averaged accuracy on seven ZCSR tasks and MMLU benchmark across LLAMA series;

FIG. 8 demonstrates Table 3 for showing comparison of the averaged accuracy of different Low-bit LoRA methods on Zero-shot Common Sense Reasoning tasks and MMLU benchmark on LLaMA2-7B;

FIG. 9 demonstrates Table 4 for showing comparison of the W4A4 quantization performance on LLaVA-Bench of LLaVA-1.5-7B;

FIG. 10 demonstrates Table 5 for showing compatibility of with DoRA on LLAMA2-7B;

FIG. 11 demonstrates Table 6 for showing ablation on when to apply rotation;

FIG. 12 demonstrates Table 7 for showing ablation on where to apply rotation;

FIG. 13 demonstrates Table 8 for showing ablation on how to apply LoRA;

FIG. 14 demonstrates Table 9 for showing the fine-tuning costs comparison on LLaMA2-7B with batch size as 8 on GPUs;

FIG. 15 demonstrating average accuracy of W4A4 LLAMA2-7B finetuned with RoLoRA for varying ranks r;

FIG. 16 demonstrates Table 10 for showing full accuracy comparison on zero-shot commonsense reasoning tasks of LLaMA series;

FIG. 17 demonstrates Table 11 for showing full accuracy on MMLU Benchmark of LLaMA series;

FIG. 18 demonstrates Table 12 for showing detailed hyper-parameters for fine-tuning different LLMs and LMMs;

19A and FIG. 19B show final activation distribution of the fine-tuned model produced using RoLoRA and LoRA; and

FIG. 20 shows a block diagram illustrating an architecture of a system according to embodiments of the present invention.

### DETAILED DESCRIPTION OF THE INVENTION

In the following description, systems and methods for fine-tuning rotated outlier-free large language models for effective weight-activation quantization and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

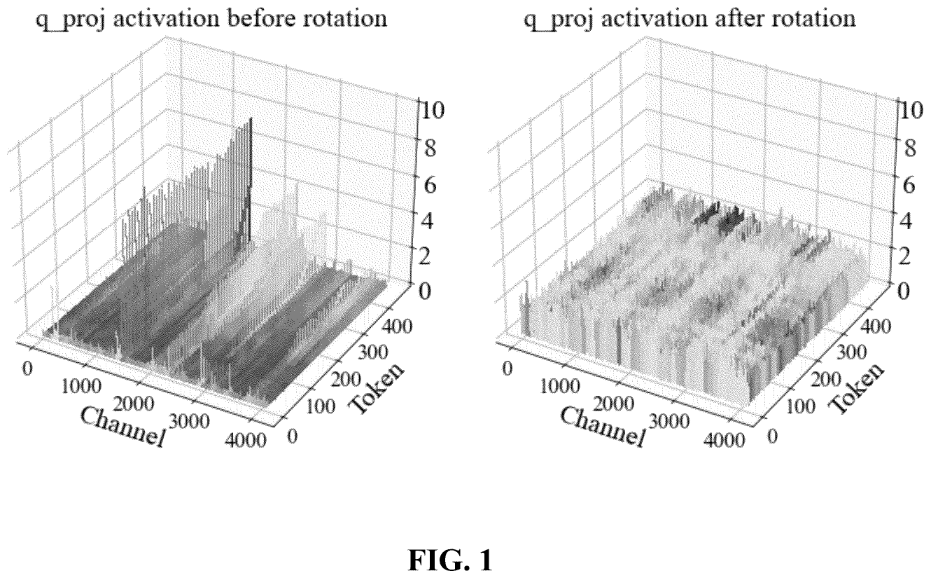

This disclosure presents a method that utilizes rotation for outlier removal in the LoRA fine-tuning setting, and investigates an optimal approach for dynamically integrating rotation with LoRA to preserve outlier-free characteristics and enhance weight-activation quantization. Motivated by this target, Rotated outlier-free Low-Rank Adaptation (RoLoRA) is provided, which initially apply in-block and between-block rotation to the pretrained LLMs, and then utilize rotation-aware finetuning to produce outlier-free fine-tuned LLMs as shown in FIG. 1, showing activation distribution before and after rotation. The optimal rotationaware fine-tuning scheme based on approximation error analysis is thus explored.

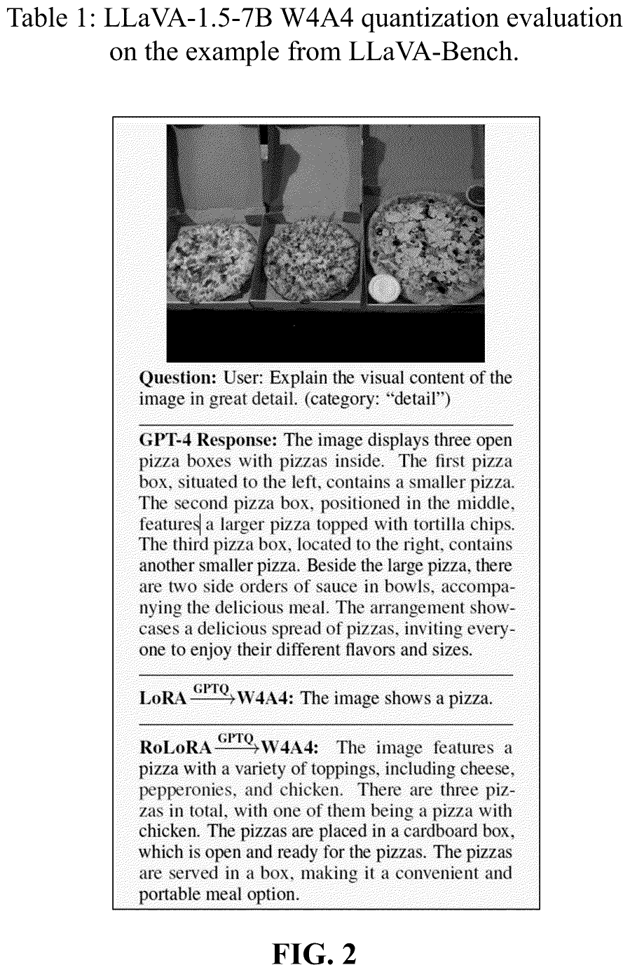

Moreover, extensive experimental results prove the effectiveness of RoLoRA across diverse LLMs, tasks, and quantization settings. RoLoRA improves the 4-bit quantization for weights and activations (W4A4) performance up to 14.6 points on the MMLU benchmark compared to LoRA. Compared with existing low-bit LoRA methods, RoLoRA outperforms previous SOTA IR-QLoRA with up to 6.0 points on the MMLU benchmark. The proposed RoLoRA is highly efficient with negligible fine-tuning overhead compared to LoRA in the same setting. RoLoRA can also improve the quantization robustness of Large Multimodal Models (LMMs) such as LLaVA, and it is observed the multimodal understanding is largely retained even after W4A4 quantization as shown in Table 1 of FIG. 2.

To make the solution provided by the present invention more understandable, the related information is provided.

### 1: Related Work

Quantization. Quantization methods are powerful tools for improving training and inference efficiency. The core insight is replacing full-precision weights and activations with lower-precision representation. Most existing LLM quantization techniques fall in the category of post-training quantization (PTQ) that directly quantize the model without extensive training. Among these LLM PTQ methods, most of them apply weight-only quantization while few methods explore weight-activation quantization. Compared to the weight-only quantization, quantizing both weights and activations enables low-precision multiply-accumulation (MAC) units. The core challenge is that outliers in activations cause high quantization errors. This work focuses on the weight-activation quantization in the LoRA pipeline.

LoRA. Considering that full parameter fine-tuning becomes computationally impractical as the scale of LLM continues to grow, Parameter-Efficient Fine-Tuning (PEFT) methods are designed to reduce the cost by training a relatively small subset of parameters. Low-Rank Adaptation (LoRA) is the most adopted PEFT method, considering its flexibility and efficiency. More recently, LoRA variants emerged to improve the effectiveness and efficiency of LoRA. Combining LoRA and quantization has also been a promising direction as quantization can further save the GPU memory in LoRA finetuning. To further reduce the information distortion of low-bit finetuning, various improvements of QLoRA have been proposed. However, these methods only apply quantization to the weight during fine-tuning to reduce memory consumption.

In the present invention, a quantized LoRA scheme is presented that explicitly considers robustness under weight-activation quantization.

### 2. Preliminary and Motivation

### 2.1 Low-Rank Adaptation (LoRA)

For a pre-trained weight matrix W₀∈ [symbol] ^{d×k}, LoRA models the weight update ΔW∈ [symbol] ^{d×k} utilizing a low-rank decomposition, expressed as AB, where A∈ [symbol] ^{d×r} and B∈ [symbol] ^{r×k} represent two low-rank matrices, with r«min(d, k). Consequently, the fine-tuned weight W′ can be represented as:

$${W}^{′} = {W}_{0} + Δ W = {W}_{0} + AB , \qquad ( 1 )$$

where W₀ remains static during the fine-tuning process, and the underlined parameters are being trained. Additionally, based on Eq. (1), we can merge the learned ΔW with the pre-trained weight W₀ can be merged and W′ in advance of deployment is obtained, and given that both W′ and W₀ both fall within the dimensionality of [symbol] ^{r×k}, LoRA and its related variants do not introduce any extra latency during the inference compared to the original model.

### 2.2 Outlier in Transformer

Starting from small-scale transformer models such as BERT and ViT, researchers have revealed that outliers exist within the weight and activation distribution. Their existence in LLMs is also observed in various studies. As shown in the left side of FIG. 1, activation outliers are distributed per channel. While these outliers improve the representative capacity of the transformers, they bring non-trivial challenges for quantization. Most previous solutions to this outlier problem in quantization can be categorized into three types: (1) Isolating these outlier values in a sub-group with higher precision, such as LLM.int8, Atom, QuiK, and AdaDim. However, there is non-trivial overhead for the grouping and mixed-precision. (2) Shifting the challenge of quantization from activations to weights, such as SmoothQuant and Omni-Quant. However, these methods negatively influence the weight quantization robustness and fail at W4A4 scenarios. (3) Rotating activation or weight matrices to remove outliers, such as QuaRot and SpinQuant. Among these methods, recent rotation-based solutions demonstrate superior effectiveness. However, previous rotationbased methods tackle the outlier challenge from a post-training perspective and have not been explored under PEFT settings.

Thus, this raises the technical question of whether the outlier-free characteristics of rotated LLMs can be preserved and effectively leveraged during PEFT. The present disclosure addresses this question and further investigates rotation-based fine-tuning strategies that maintain such characteristics to enhance the robustness of weight-activation quantization.

2.3 Eliminating Outlier with Rotation

A rotation matrix R is defined as an orthogonal matrix with |R|=1, where R also follows the characteristics of the orthogonal matrix that RR^{T}=I. If the entries of R are either +1 or −1, it becomes a Hadamard matrix H. Based on the definition, the matrix H with 2^{k} entries can be efficiently generated based on the Hadamard transform (also known as the Walsh-Hadamard transform as an example of a generalized class of Fourier transforms):

$${H}_{{2}^{k}} = [ \begin{matrix}{H}_{{2}^{k - 1}} & {H}_{{2}^{k - 1}} \\ {H}_{{2}^{k - 1}} & - {H}_{{2}^{k - 1}}\end{matrix} ] = {H}_{2} ⊗ {H}_{{2}^{k - 1}} , \qquad ( 2 )$$

where ⊗ denotes the Kronecker product. The rotation is highly efficient as the matrix-vector product with a d×d Hadamard matrix H_{d}X requires [symbol] (d log 2(d)) operations. Previous research has revealed that applying rotation on the weights of pre-norm transformers can retain its computational consistency and further lead to fewer outliers in the weight and activation distribution. Concretely, the multiplication of weight matrices with a rotation matrix statistically blends weights with large and small magnitudes together into a more Gaussian-like distribution, thus producing activations with fewer outliers and easier to quantize.

### 3. Method

Motivated by existing challenges of activation outliers and the success of rotation-based solutions, Rotated outlier-free Low-Rank Adaptation (RoLoRA) is introduced. RoLoRA initially apply in-block and between-block rotation to the pre-trained LLMs, and rotation-aware fine-tuning on the rotated LLMs will retain the optimal outlier-free characteristic, producing fine-tuned LLMs highly robust to weight-activation quantization.

### 3.1 Applying Rotation

Prior to initiating fine-tuning with rotation, the model is modified to maintain computational invariance before and after the application of rotation. First, it is necessary to eliminate any scaling operation in the normalization module. For the LLaMA series, this can be implemented by absorbing the RMSNorm scale parameters α into the weight matrix right after the RMSNorm layer.

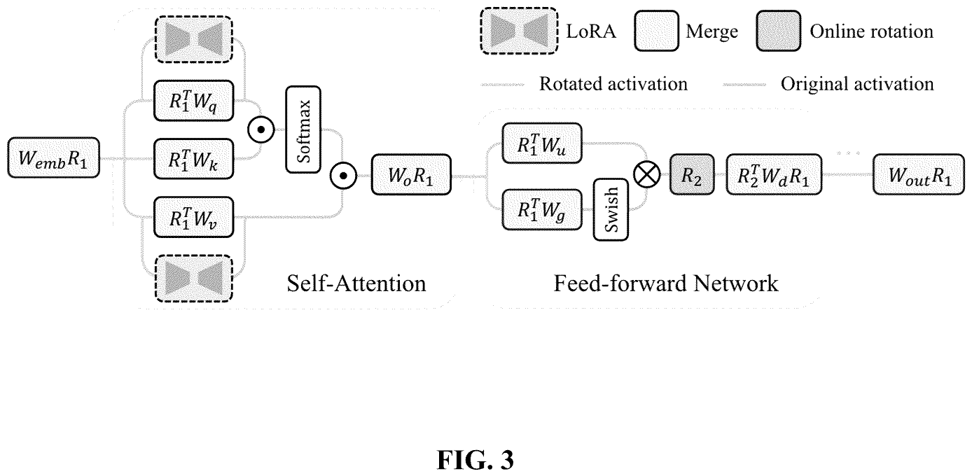

Then, a between-block rotation is performed to eliminate outliers in the between-block activation. FIG. 3 shows overview of the proposed approach of RoLoRA according to one embodiment of the present invention. As shown in FIG. 3, the weight matrices in LLMs are classified into two groups: left-side weights, including W_{q}, Wₖ, Wᵥ in self-attention modules, and Wᵤₚ, W_{gate} in feedforward network modules (which corresponds to the Wᵤ, W_{q} in FIG. 3); right-side weights, including Wₒ in self-attention modules and W_{down} in feed-forward network modules. For the weights of these two groups, different rotation strategies are adopted with:

$${W}_{left}^{R} ← {RW}_{left} , {W}_{right}^{R} ← {W}_{right} {R}^{- 1} , \qquad ( 3 )$$

where the rotation R is randomly generated Hadamard matrix. As the input X is also rotated before the embedding layer as X←XR⁻¹, and the output Y is rotated after lm_head as Y←RY, the final output of the model will be identical to the original model. To avoid overflow issues in the rotation process, the FP16 weights are converted to FP64 and are converted back after the multiplication. The conversion of weight precision is only conducted once at the beginning of the rotation merging and the precision of the rotated weights will keep FP16 during the fine-tuning and inference. There will be no overhead for conversion in the actual inference because the precision during inference is always low-bit (W4A4/W6A6). These rotations are applied before any training and inference, which indicates that there will be no overhead after the merging to original weights.

The rotation that directly applies to weights effectively reduces the outlier in between-block activation, and the operation is referred to as Between-Block Rotation (BBR). FIG. 1 demonstrates the effect of applying BBR as the activation distribution is smoother and de-centralized. However, another challenge remains that the activation in these modules still suffers from outliers, especially prevalent in FFN as discussed in previous research. Direct application of rotation similar to BBR is not feasible due to non-linear operations such as SwiGLU in the FFN. To address this, an online rotation node is adopted before inputting the activation to W_{down}. This online rotation is implemented following the fast Hadamard kernel, which can be seen as a layer dynamically rotating the activation. This online rotation operation is highly efficient, as the fast Hadamard kernel on CUDA is used, and the overhead is negligible during training and inference. It is referred to as In-Block Rotation (IBR). It is noted that IBR can also be applied to the self-attention module, but it is observed in the experiments of Table 7 of FIG. 12 that there is no performance improvement with this rotation.

### 3.2 Rotation-Aware Fine-Tuning

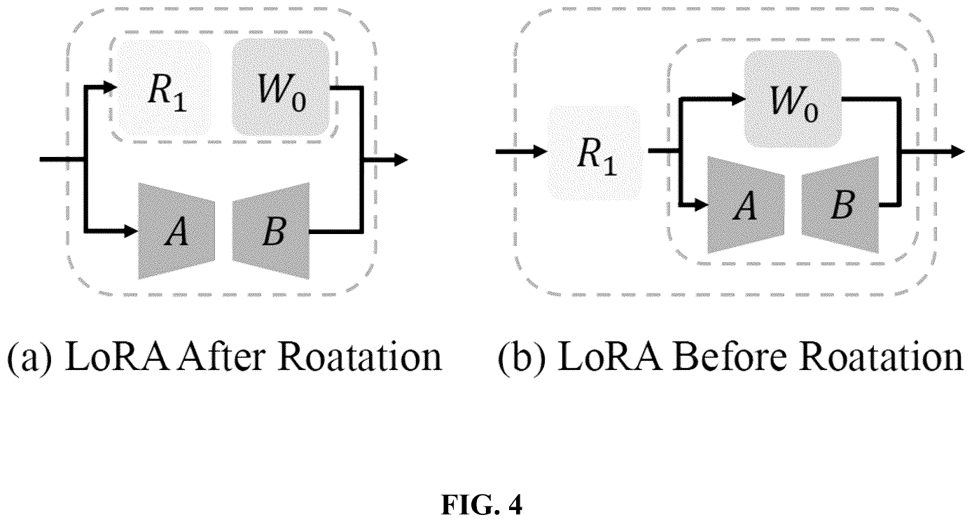

After performing both BBR and IBR, the between-block and in-block activation outliers are eliminated. This characteristic can lower the quantization error during QLoRA training, enabling a more accurate gradient estimation and smoother optimization for fine-tuning. However, existing research revealed that outliers will change distribution or emerge during fine-tuning and pre-training. This poses a new challenge of dynamically integrating rotation into LoRA to effectively maintain outlier-free characteristics. To design the optimal rotation-aware fine-tuning scheme, the approximation difficulty when rotation is applied is first analyzed. It is assumed that the optimal weight distribution for specific downstream tasks is W*, which is approximated using the LoRA weights AB merged with the pre-trained weights W₀. The optimization of LoRA fine-tuning could be indicated as:

$${min}_{A , B} {‖ {W}^{*} - ( {W}_{0} + AB ) ‖}_{F} , \qquad ( 4 )$$

where the ∥·∥_{F} denotes the Frobenious norm. To insert the LoRA module in the rotated models, two rotation-aware fine-tuning schemes are proposed, namely LoRA After Rotation (LAR) and LoRA Before Rotation (LBR), as shown in FIG. 4. FIG. 4 shows two schemes for performing rotation-aware fine-tuning: (a) LAR; and (b) LBR.

In LAR, the rotation matrix is first merged with the pre-trained weights, and R₁Wₒ+AB is used to approximate W*. For LBR, the LoRA weights are first merged and then rotated, resulting in R₁(W₀+AB). The optimal weights are assumed to be the full fine-tuning results W_{FT}, and the optimization for these two schemes becomes:

$$LAR : {min}_{A , B} {‖ AB - {O}_{LAR} ‖}_{F} , {O}_{LAR} = {W}_{FT} - {R}_{1} {W}_{o} \qquad ( 5 )$$

$$LBR : {min}_{A , B} {‖ AB - {O}_{LBR} ‖}_{F} , {O}_{LBR} = {R}_{1}^{- 1} {W}_{FT} - {W}_{o}$$

the final optimization is very different. SVD of the approximation target O_{LAR} is applied, O_{LBR}∈ [symbol] ^{d×k} by O=USV^{T}. The principal singular values and vectors in the first r dimensions are utilized to initialize the LoRA weights with rank r as A∈ [symbol] ^{m×r} and B∈ [symbol] ^{r×n}:

$$A = {U}_{[ : , : r ]} {S}_{[ : r , : r ]}^{1 / 2} ∈ {ℝ}^{d \times r} , B = {S}_{[ : r , : r ]}^{\frac{1}{2}} {V}_{[ : , : r ]}^{T} ∈ {ℝ}^{r \times k} , \qquad ( 6 )$$

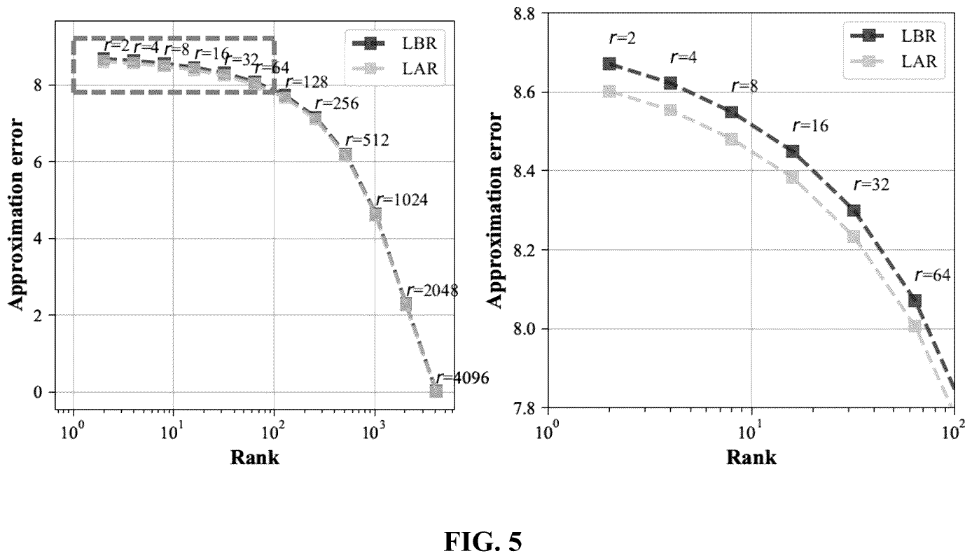

The approximation error under different rank choices r is evaluated to simulate LoRA in the two rotation schemes. A pre-trained LLAMA2-7B model is used as W₀, and a fully fine-tuned model on the Alpaca dataset is used as W_{FT} in the experiments, as shown in FIG. 5, demonstrating SVD approximation error of optimization targets with different LoRA-rotation integration schemes. Based on the results, LAR outperforms LBR in low-rank settings with lower approximation error, suggesting LAR is the better design for rotation-aware finetuning. The better approximation indicates that after the two-stage merging with rotation matrices and LoRA weights, the final weights can still retain the outlier-free property, which is further validated by ablation experiments in Section 4.5.

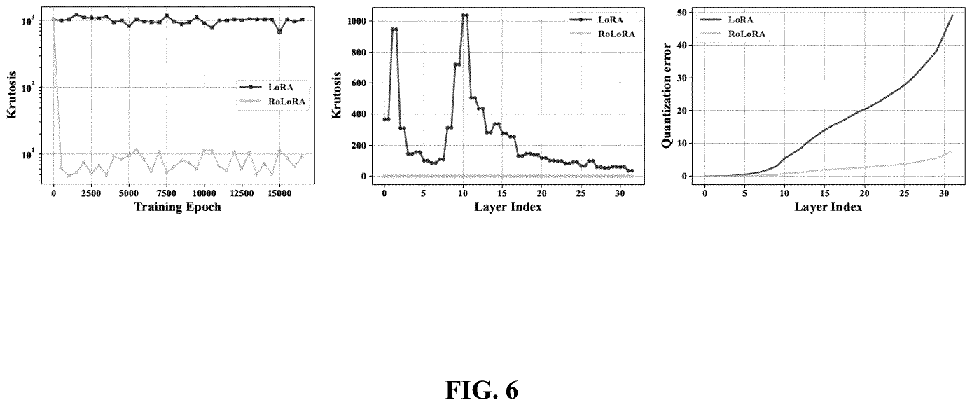

As a result of the optimal rotation-aware finetuning scheme under the LAR setting, the outlier-free characteristic can be effectively retained during LLM fine-tuning, as shown in FIG. 6, demonstrating left, middle, and right parts. The left part involves the training dynamics of the average Kurtosis of activations; the middle part involves the distribution of Kurtosis of activations across all layers in the final model after fine-tuning with LoRA and RoLoRA; and the right part involves the accumulative quantization error of W4A4 GPTQ across all layers in the final model after fine-tuning with LoRA and RoLoRA.

### 4. Experiments

### 4.1. Settings

Model, LoRA, Quantizer. The models for the provided experiments include LLAMA2-7B/13B and LLaMA3-8B. The training pipeline is implemented based on the settings provided in LLaMA-Factory. The dataset for fine-tuning is Alpaca with 52K samples. The weight PTQ methods are the baseline Round-To-Nearest (RTN) and widely used GPTQ, and the activation quantizer is RTN across all experiments. Per-channel symmetric quantization is applied to the weights, and per-tensor quantization is applied to the activations.

Tasks. The provided RoLoRA is verified on seven zero-shot commonsense reasoning tasks using EleutherAI evaluation harness. These tasks include BoolQ, PIQA, HellaSwag, WinoGrande, ARCeasy and ARC-challenge, and OBQA. Additionally, the accuracy of Massively Multitask Language Understanding (MMLU) benchmark for the provided evaluation is provided as well.

Baselines. It is considered that two settings for experiments. The first is conducting FP16 fine-tuning with RoLoRA, where the W4A4 and W6A6 quantization results are compared with LoRA. The second is conducting RoLoRA fine-tuning with 4-bit weight quantization, which is referred to as QRoLoRA, and comparing the W4A4 performance with other low-bit LoRA methods including QLORA, LoftQ, and IR-LoRA.

### 4.2 Main Results

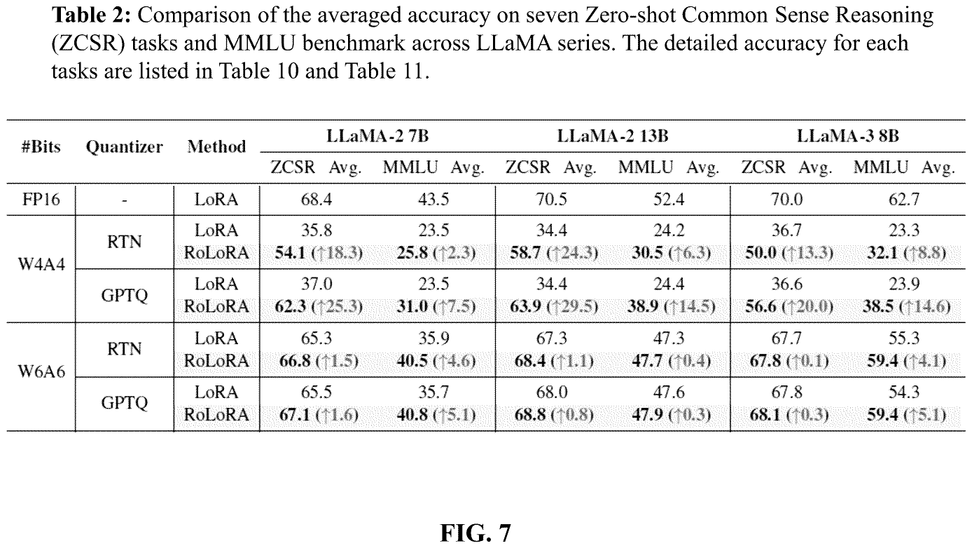

RoLoRA is first evaluated against LoRA in FP16 fine-tuning and then weight-activation PTQ is applied to the fine-tuned LLMs. To ensure a fair comparison, both RoLoRA and LoRA use the same settings (rank, epoch, learning rate, etc.). As listed in Table 2 of FIG. 7, RoLoRA enhances the quantization robustness of the LLaMA series across various quantization settings on zero-shot commonsense reasoning and MMLU benchmarks. Specifically, for the W4A4 low-bit setting, RoLoRA outperforms LoRA with an absolute up to 29.5% and 14.6% on ZCSR and MMLU, respectively. Although MMLU contains multiple-choice questions with four options, the relative accuracy below 25% is still meaningful because we observe that some low-bit quantized LLMs cannot even be instructed to give a choice from four options. The proposed method can better preserve the reasoning performance, thus ensuring most of the time LLaMA is still following the instructions to answer the question rather than generating meaningless tokens. Furthermore, RoLoRA makes it feasible for near-lossless W6A6 quantization of the LLaMa series across multiple tasks.

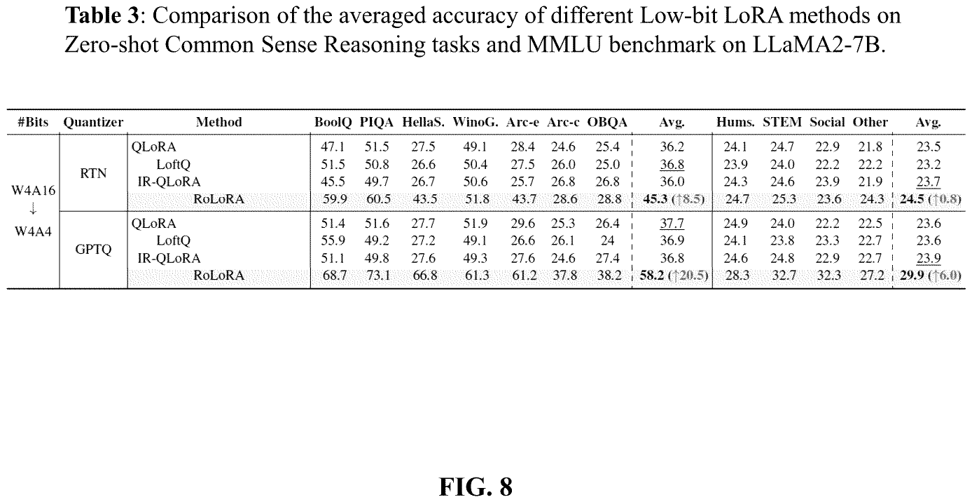

RoLoRA is further evaluated against QLoRA and serval baseline methods, including LoftQ, IR-QLORA, on 4-bit fine-tuning and then apply W4A4 PTQ to the low-bit fine-tuned LLAMA2-7B. The performance across seven commonsense reasoning tasks and four MMLU subtasks is detailed in Table 3 of FIG. 8. It can be seen that RoLoRA consistently improves the performance of the quantized model using the same quantizer. In particular, for W4A4 GPTQ, RoLORA exceeds QLoRA by 20.5% on the average accuracy of commonsense reasoning tasks. Across the experiments on both FP16 and 4-bit fine-tuning, we observe that RoLoRA achieves higher performance improvement on the LLMs quantized by GPTQ in general. This observation supports the conclusion that RoLoRA retains outlier-free activations during fine-tuning, whereas GPTQ primarily reduces quantization error for weights but not for activations.

### 4.3 Visual Instruction Tuning

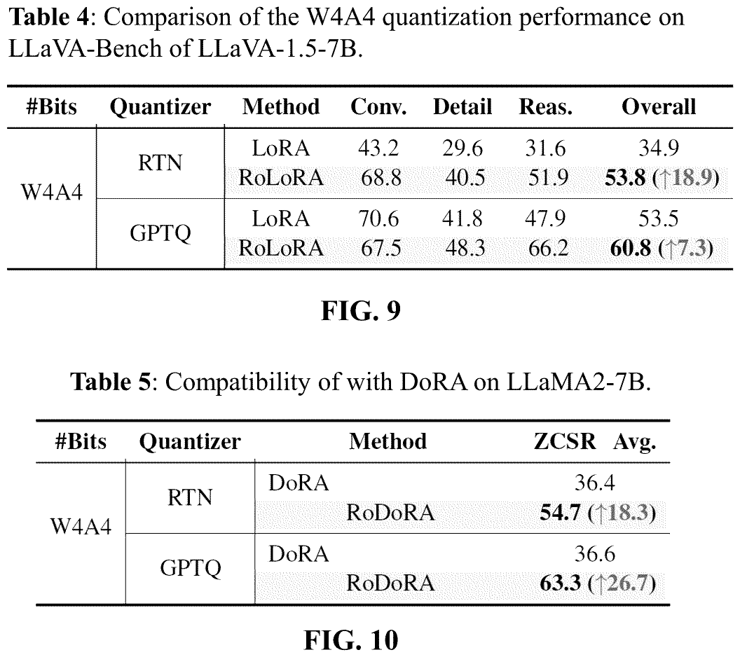

The effectiveness of RoLoRA is verified on visual instruction tuning tasks with LLaVA-1.5-7B, which consists of a language model, Vicuna-7B, and a vision encoder CLIP ViT-L-336px. The LLaVA-1.5-7B is finetuned on LLaVAInstruct-150K3. Quantization is applied only to the language model, and the LLaVA is evaluated using the quantized Vicuna model and a full-precision vision encoder on the LLaVA-Bench (COCO) benchmark with GPT-4. The relative score across the conversation, detail description, and complex reasoning are reported in Table. 4 of FIG. 9, where it can be observed from the results that RoLoRA helps improve quantization robustness and better preserve multi-modal capabilities during PTQ, with an overall score improvement of up to 18.9. An example of the detail description task on a given image is also provided, as shown in Table. 1 of FIG. 2. While the W4A4 LoRA model only gives a rough superficial description of the images, the proposed W4A4 RoLoRA model fully elaborates the details, such as the toppings and containers.

4.4. Compatibility with Other LoRA Variants

The proposed method is further verified on a representative LoRA variant, DORA. DoRA decomposes the pre-trained weight into magnitude and directional components and finetunes both. The same scheme is followed in the rotation-aware fine-tuning stage described herein, and this scheme is referred to as RoDoRA. As shown in Table 5 of FIG. 10, RoDORA achieves 18.3% and 26.7% higher accuracy on W4A4 LLAMA2-7B using RTN and GPTQ as quantizers. The results of RoDoRA also outperform RoLoRA, showing the compatibility of our methods with cutting-edge LoRA variants and potential to further enhance the performance of weight-activation quantization.

### 4.5 Ablation Study and Analysis

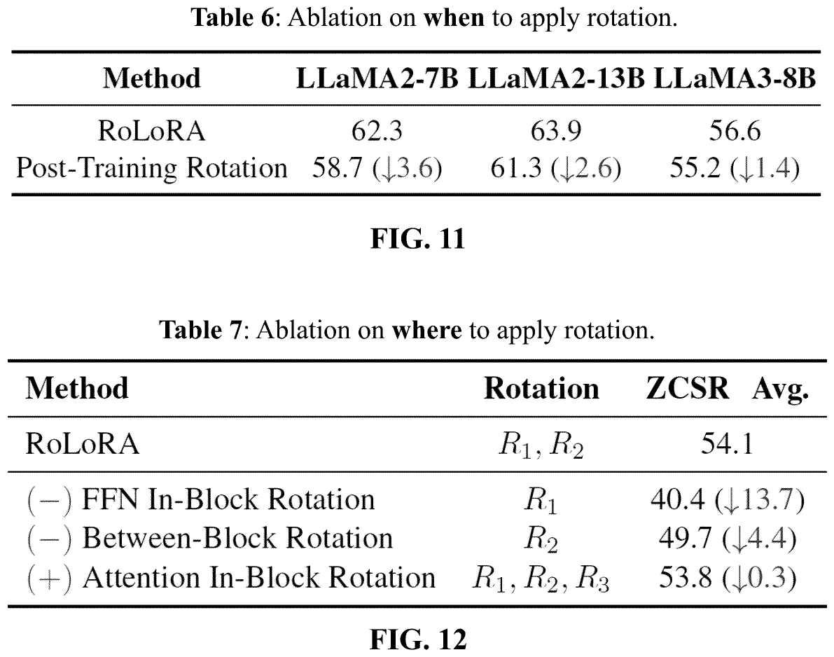

When to Apply Rotation? Different from the Rotation-Aware Fine-tuning (RAF) scheme that rotates the LLMs before LoRA fine-tuning, rotation can be directly applied to an already fine-tuned LoRA model. This possible paradigm of LoRA→Rotate→PTQ is referred to as post-training rotation. Post-training rotation is evaluated using the same training setting as RoLoRA across the LLAMA series. The W4A4 GPTQ performance on seven zero-shot commonsense reasoning tasks are listed in Table 6 of FIG. 11. The results indicate that applying rotation before LoRA can consistently enhance the quantization robustness of the fine-tuned LLMs.

Where to Apply Rotation? In FIG. 3, two types of rotation are introduced in the provided pipeline, namely Between-Block Rotation applied on all weight matrices and In-Block Rotation applied on down_proj in FFN. As discussed in Section 3.1, it can also apply a similar head-wise IBR R₃ for self-attention. The R₃ rotates the Wᵥ and Wₒ in FIG. 3 by

$${W}_{v}^{R} ← {W}_{v} {R}_{3} , {W}_{o}^{R} ← {R}_{3}^{- 1} {W}_{o} .$$

These choices for rotation targets are verified on LLaMA2-7B W4A4 PTQ shown in Table 7 of FIG. 12. The results suggest that applying and only applying both R₁ and R₂ is the best option to eliminate outliers.

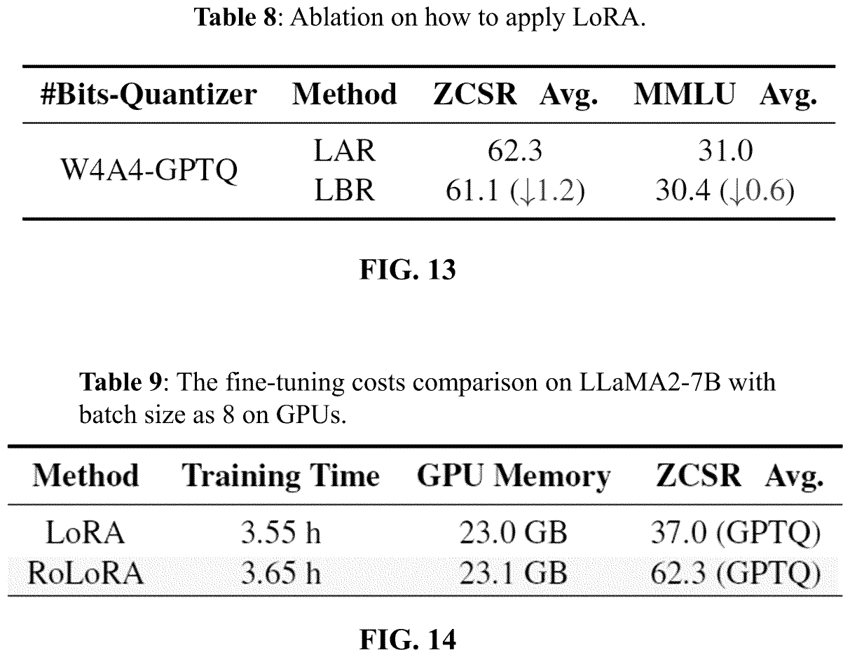

How to Apply LoRA? In Section 3.2, two rotation-aware fine-tuning schemes are proposed: LoRA After Rotation (LAR) and LoRA Before Rotation (LBR), as shown in FIG. 4. It is proved that LAR is the better paradigm based on the approximation error analysis compared with full-finetuning. In Table 8 of FIG. 13, the W4A4 quantization performance of two schemes is quantitatively compared with the fine-tuning of the LLaMA2-7B. The LAR scheme demonstrates better effectiveness, which corresponds to the approximation analysis shown in FIG. 5.

Outliers. Retaining the outlier-free characteristic during LLM fine-tuning is the most important motivation for RoLoRA. To quantitatively validate the effect of outlier elimination, kurtosis

$$κ = \frac{{\sum }_{i}^{k} {( {x}_{i} - μ )}^{4}}{{σ}^{4} + ϵ}$$

of the activation is sued to measure the outlier presence, where u and o are respectively the empirical mean and standard deviation of activation distribution. Generally, a large kurtosis value indicates an activation distribution with heavy tails and a higher likelihood of outliers. The kurtosis dynamic is visualized during fine-tuning with LoRA and RoLoRA in FIG. 6. In the early training epochs, the rotation effectively suppresses the activation outliers. The rotation-aware fine-tuning can retain this optimal property. After fine-tuning with RoLoRA, as shown in FIG. 5, the kurtosis K across all layers is significantly reduced, which further gives rise to the low quantization error compared to the LoRA baseline. The activation distribution of RoLoRA is compared against LoRA across layers in FIG. 19A and FIG. 19B.

LoRA rank settings. The robustness of LoRA and RoLoRA with respect to various rank settings r∈{4, 8, 16, 32, 64} is explored during the fine-tuning of LLAMA2-7B, and the models are evaluated on zero-shot commonsense reasoning tasks. The optimal rank setting for RoLoRA and LoRA are 16 and 32, respectively. The lower optimal rank indicates the potential of our RoLoRA to save trainable parameters. Overall, RoLoRA consistently outperforms LoRA regardless of the rank setting, demonstrating its robustness.

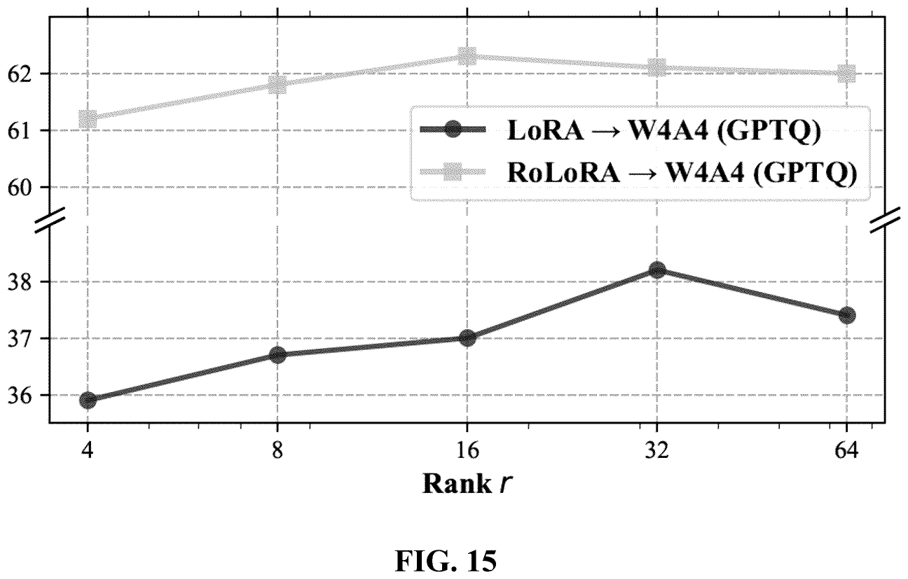

Efficiency. For the fine-tuning efficiency of RoLoRA, the additional training time is only incurred by the online rotation operation (R₂ in FIG. 3) as the other rotation (R₁ in FIG. 3) can be directly merged into the original weights. There is only one additional matrix multiplication, and the increased rotation parameter can theoretically be considered negligible. The fine-tuning cost of RoLoRA, as compared to LoRA under identical settings (rank r=16, batch size of 8, and a total of 3 epochs), is reported in Table 9 of FIG. 14, where RoLoRA significantly improve W4A4 quantized LLaMA2-7B performance with extremely low additional overhead, as shown in FIG. 15 demonstrating average accuracy of W4A4 LLAMA2-7B finetuned with RoLoRA for varying ranks r.

### 5. Appendix Material

This section serves as additional support for the foregoing discussion.

### 5.1. Detailed Evaluation Results

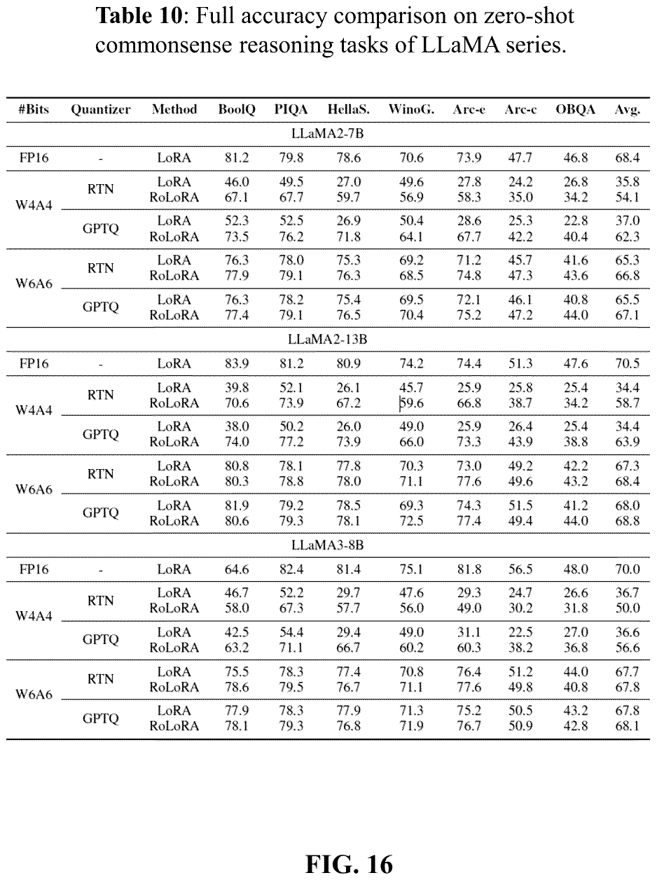

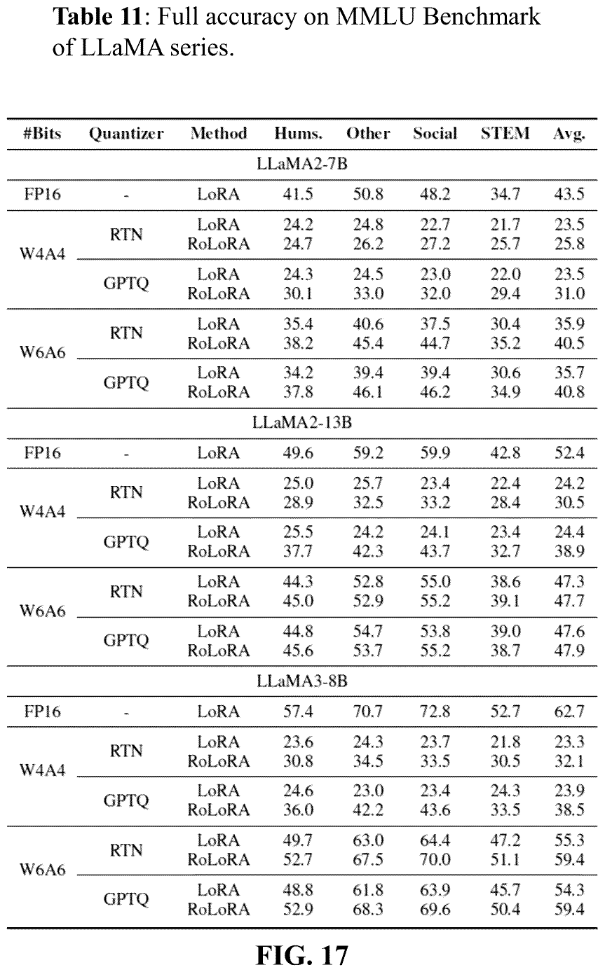

Table 10 of FIG. 16 and Table 11 of FIG. 17 listed the full evaluation results on zero-shot commonsense reasoning tasks and MMLU benchmarks, respectively. ‘acc_norm’ is used in the evaluation report given by EleutherAI evaluation harness as the accuracy if there are such metrics. Otherwise, ‘acc’ is used.

### 5.2. Hyper-Parameters for Reproduction

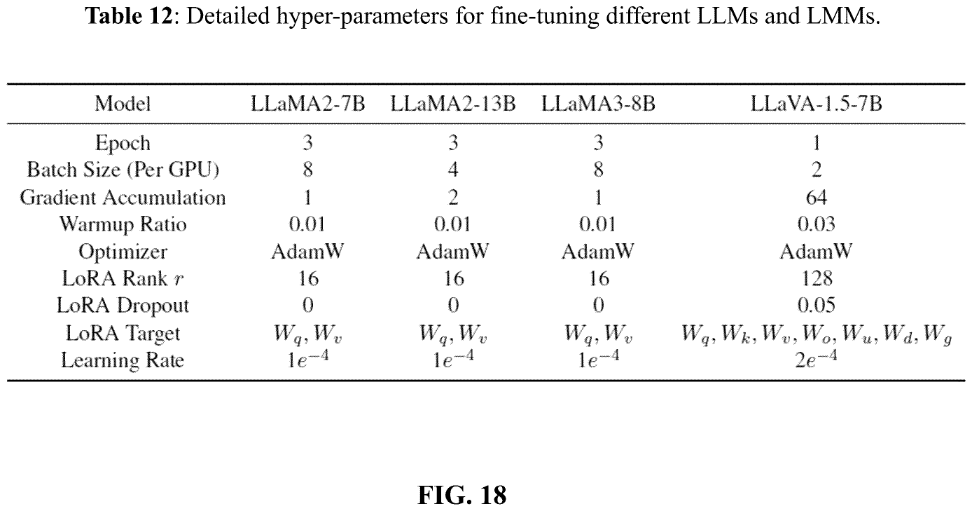

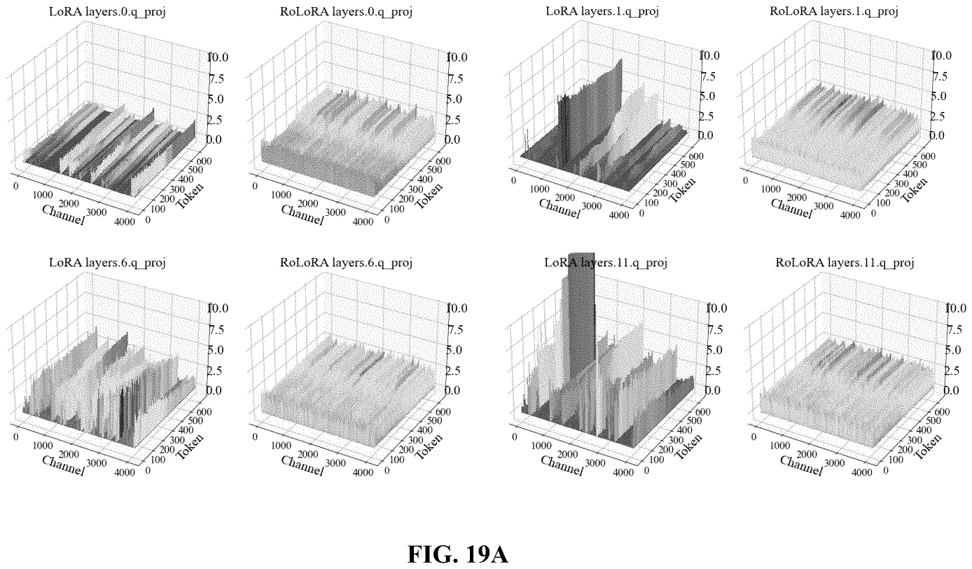

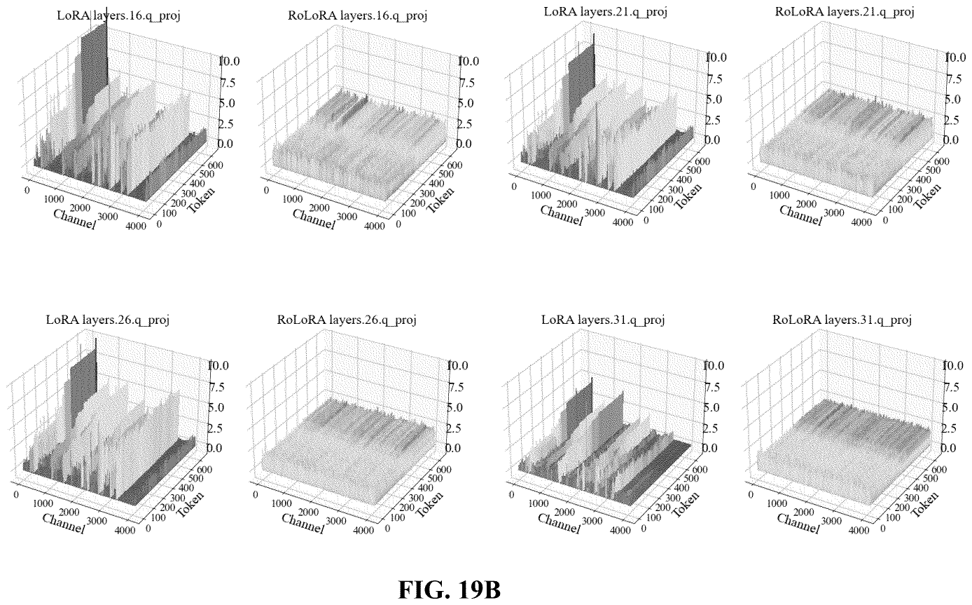

In Table 12 of FIG. 18, the detailed hyper-parameters are listed for reproducing RoLoRA and LoRA results. No hyperparameter search is applied for the purpose of improving accuracy.

### 5.3. Activation Distribution Visualization

We visualize the magnitude of the activation of fine-tuned LLAMA2-7B using LoRA and RoLoRA in FIG. 19A and FIG. 19B, showing final activation distribution of the fine-tuned model produced using RoLoRA and LoRA, in which the output activation of q_proj is selected across layers with the index of 0, 1, 6, 11, 16, 21, 26, 31. The visualizations reveal a noticeable amount of outliers presented in the LoRA fine-tuned model, but are highly eliminated in RoLoRA counterpart.

Based on the foregoing technical architecture and associated fine-tuning and quantization workflow, the present disclosure provides a concrete computer-implemented system configured to process, rotate, fine-tune, and quantize large-scale neural network models. The disclosed system comprises multiple interconnected modules that operate on high-dimensional weight and activation tensors produced by large language models (LLMs). These operations include matrix rotations using Hadamard transforms, insertion of low-rank adaptation modules, rank-specific optimization based on SVD, and low-bit quantization across both weights and activations. The nature of the processing requires non-trivial computational resources and cannot be performed by human mental processes or with paper-and-pencil calculation, particularly the dynamic integration of rotation-aware fine-tuning and the in-memory persistence of multi-stage model objects. Accordingly, the claimed system is rooted in computer technology and provides a practical implementation framework for improving the efficiency and robustness of quantized LLM deployment in real-world applications, including language reasoning and multimodal instruction following.

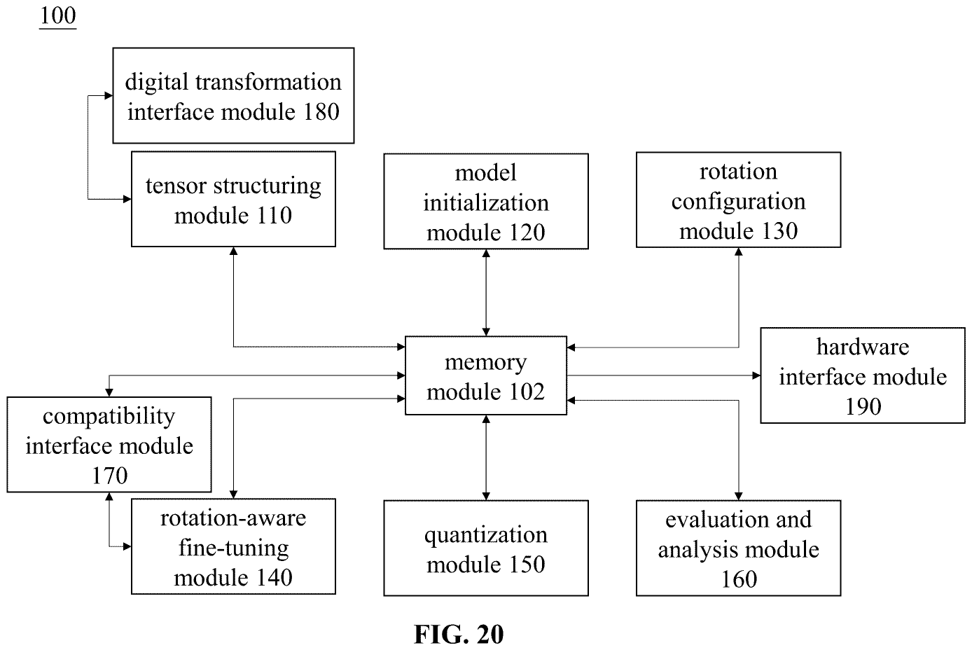

FIG. 20 shows a block diagram illustrating an architecture of a system 100 according to embodiments of the present invention. The system 100 for fine-tuning rotated outlier-free large language models (LLMs) under low-bit weight-activation quantization comprises a set of interconnected modules implemented on computer hardware. Specifically, the system 100 includes a memory module 102, a tensor structuring module 110, a model initialization module 120, a rotation configuration module 130, a rotation-aware fine-tuning module 140, a quantization module 150, and an evaluation and analysis module 160.

The memory module 102 may include one or more types of non-transitory computer-readable storage media, such as dynamic random-access memory (DRAM), static RAM (SRAM), high Bandwidth Memory (HBM). The memory module 102 is configured to store intermediate and final model objects, including structured tensors, rotation-transformed weights, fine-tuned parameters, and quantized representations, in a format accessible to the other modules of the system 100.

The tensor structuring module 110 is configured to receive mathematical representations such as weight matrices, activation signals, and rotation parameters, and process them into structured digital formats suitable for computer processing. This structuring process involves encoding high-dimensional tensors into memory-aligned arrays, adjusting bit precision (e.g., FP16 to FP4), and preparing the data layout for efficient computation. The structured tensor data is output to and stored in the memory module 102, making it accessible to downstream modules.

The model initialization module 120 is configured to retrieve the structured model data from the memory module 102 and modify its internal architecture to maintain computational invariance during subsequent rotation. The initialization process includes removing scaling operations from normalization layers and merging scale parameters into adjacent weight matrices. The initialized model object is then stored back into the memory module 102 and serves as input to the rotation configuration module 130.

The rotation configuration module 130 is configured to retrieve the initialized model object from the memory module 102 and apply orthogonal rotation transformations to suppress outliers in both weights and activations. The initialized model object comprises a set of structured weight matrices and activation flow definitions corresponding to different layers of the large language model, including attention projection weights, feed-forward projection weights, and residual activation paths. Upon retrieval, the rotation configuration module 130 parses the model object to identify specific parameter groups subject to transformation. In particular, the rotation configuration module 130 extracts: (1) the attention and feed-forward projection weight matrices (e.g., output, up, and down projections), and (2) the activation pathways feeding into nonlinear transformations (e.g., SwiGLU activations).

The rotation configuration module 130 then generates orthogonal rotation matrices (e.g., Hadamard matrices or block-diagonal variants) and applies: (i) between-block rotation to the identified projection weights by multiplying the original weight matrix by the rotation matrix and its transpose, and (ii) in-block rotation to the intermediate activation tensors via post-normalization insertion of a fast Hadamard transform. These operations modify the internal tensor paths of the model object to suppress statistical outliers in both parameter space and activation space, while preserving functional equivalence. The updated, rotated model object is then written back into the memory module 102 for access by the rotation-aware fine-tuning module 140.

The rotation-aware fine-tuning module 140 is configured to retrieve the rotated model object from the memory module 102 and perform parameter-efficient fine-tuning by inserting and updating low-rank adaptation components. The rotated model object comprises rotation-transformed weight matrices across attention and feed-forward layers. Upon retrieval, the rotation-aware fine-tuning module 140 parses the model object to identify the applicable insertion points for low-rank modules and selects a fine-tuning strategy based on preconfigured settings, such as LoRA After Rotation (LAR) or LoRA Before Rotation (LBR).

In one embodiment, the rotation-aware fine-tuning module 140 operates under a LAR strategy, in which the low-rank components are inserted after the application of rotation, such that the rotated weights serve as the base parameters. In this configuration, the low-rank update is computed and merged directly in the rotated weight space, preserving the outlier-free characteristics introduced by the rotation configuration module 130. The base matrix subject to low-rank decomposition is therefore the rotation-aligned matrix.

In another embodiment, the rotation-aware fine-tuning module 140 operates under a LBR strategy, in which the low-rank modules are inserted prior to the rotation process. In this configuration, the fine-tuning is performed in the original unrotated weight space, and the resulting adapted weights are subsequently transformed via rotation. This configuration enables compatibility with existing LoRA implementations but does not retain the full statistical benefits of early outlier suppression during training.

In both strategies, the rotation-aware fine-tuning module 140 applies singular value decomposition (SVD) to approximate full fine-tuned updates with low-rank components and initializes the trainable matrices accordingly. During the fine-tuning phase, only the low-rank matrices are updated while the base (rotated or unrotated) weights remain frozen.

The effect of the rotation-aware fine-tuning module 140 is to transform the rotated model object, which is originally structured with outlier-suppressed but task-neutral weight matrices, into a task-adapted model object comprising both frozen base parameters and learned low-rank deltas. Prior to fine-tuning, the model object includes only rotation-transformed weights that are optimized for quantization robustness but do not yet contain task-specific adjustments. After the insertion and training of low-rank components, the model object contains additional parameter matrices that encode task-adaptive knowledge while preserving the statistical advantages introduced by the rotation. As a result, the post-finetuning model object exhibits improved inference accuracy under low-bit conditions and serves as a deployment-ready representation stored in the memory module 102.

Upon completion of training, the rotation-aware fine-tuning module 140 merges the base and low-rank components to produce an updated model object, which is then stored in the memory module 102 for subsequent quantization by the quantization module 150.

The quantization module 150 is configured to retrieve the fine-tuned model object from the memory module 102 and perform quantization on both weight parameters and activation tensors. The fine-tuned model object includes a combination of frozen base weights and learned low-rank update matrices, along with defined activation pathways corresponding to each model layer. Upon retrieval, the quantization module 150 identifies and extracts the relevant tensor components from the model object, including per-layer weight matrices and representative activation ranges. The quantization module 150 applies per-channel symmetric quantization to the weight matrices, aligning quantization granularity with individual output channels, and applies per-tensor quantization to the activation tensors based on their statistical range characteristics. The quantization strategy may be selected from configurable backends such as Round-To-Nearest (RTN) or GPTQ, depending on the deployment constraints. Following quantization, the resulting model object comprises low-bit encoded representations of both weights and activations, which are stored in the memory module 102 as a deployment-ready format for inference or evaluation.

Upon completion of the quantization process by the quantization module 150, the system 100 produces a fully structured and memory-resident model object configured for direct deployment in downstream inference systems. This model object, comprising low-bit encoded weights and activations, satisfies the requirements for compatibility with hardware accelerators and software inference frameworks, and represents the final output of the system's fine-tuning and quantization pipeline. Accordingly, the quantization module 150 marks the terminal stage of the model transformation process required for producing an executable, low-bit large language model. That is, the final output of the system 100 is a quantized large language model stored in the memory module 102, in which the model includes rotated, fine-tuned, and low-bit quantized parameters that are configured for direct deployment in inference tasks.

In some embodiments, the evaluation and analysis module 160 may be employed to further validate and optimize the performance of the quantized model object prior to or during deployment. The evaluation and analysis module 160 serves as an auxiliary enhancement component, enabling quality assurance, performance benchmarking, and adaptive improvement of quantization strategies without altering the functional readiness of the already deployable model. The evaluation and analysis module 160 is configured to retrieve the quantized model from the memory module 102 and assess its performance on benchmark tasks, including but not limited to commonsense reasoning, multitask learning, and visual instruction following. The evaluation and analysis module 160 computes metrics such as layer-wise activation kurtosis and quantization error to evaluate the robustness of outlier suppression. The evaluation results can be optionally written back to the memory module 102 for auditing, visualization, or further optimization.

In some embodiments, the system may further include a compatibility interface module 170 configured to adapt the system 100 for LoRA variants such as DORA. The compatibility interface module 170 retrieves decomposed weight representations from the memory module 102, performs variant-aware re-integration of directional and magnitude components, and invokes the rotation-aware fine-tuning module 140 accordingly.

In some embodiments, the system 100 further comprises a digital transformation interface module 180 configured to translate symbolic or continuous mathematical structures, such as floating-point tensors, rotation matrices, and low-rank projection vectors, into hardware-compatible, memory-aligned digital formats. The digital transformation interface module 180 cooperates with the tensor structuring module 110 and includes precision-conversion logic, alignment padding circuits, and hardware buffer control elements. The output is a set of structured tensor blocks mapped directly into non-transitory computer-readable storage regions, such that subsequent modules operate over physical, byte-addressable objects rather than mathematical abstractions.

In some embodiments, the system 100 further comprises a hardware interface module 190 configured to interface the memory-stored quantized model object (e.g., the model object stored in the memory module 102) with inference hardware (e.g., graphics processing unit (GPU), neural processing unit (NPU), or tensor processing unit (TPU)). The hardware interface module 190 includes driver-level logic for model loading, tensor layout verification, and compatibility signaling for deployment to hardware accelerators.

The system 100 is implemented using a computer device comprising at least one processor and one or more non-transitory computer-readable storage media (e.g., DRAM, flash memory, or NVRAM). Each module of the system 100 operates through executable logic stored in memory and executed by a processor. Intermediate and final model artifacts, including rotated weights, fine-tuned parameters, and quantized tensor objects, are stored as structured digital artifacts in memory module 102. These artifacts are not symbolic or abstract; instead, they exist in addressable binary formats configured for downstream machine inference.

Through the coordinated interaction of modules of the system 100, symbolic or mathematical model descriptions are transformed into structured digital model artifacts that undergo physical tensor transformation, adaptive fine-tuning, and deployment-ready low-bit quantization. These transformations, including tensor rotations, LoRA merging, SVD initialization, and quantization, are implemented as physical data transformations in memory, producing machine-readable, memory-resident model objects comprising low-bit encoded matrices and activation representations. Each module performs read and write operations via the memory module 102, ensuring that all intermediate and final states are concretely represented in memory. The resulting model objects can be directly utilized by language model inference engines and hardware accelerators. Accordingly, the system 100 is not directed to a mental process or mathematical abstraction, but instead provides a practical, computer-implemented solution for generating deployable LLM artifacts with improved efficiency and quantization robustness.

In an available execution workflow, the system 100 is initialized on a computing device comprising at least one processor and memory, such as a server-grade machine with access to GPU or NPU inference accelerators. A pre-trained large language model, for example a LLaMA-based architecture, is loaded into the system 100 in its original uncompressed form. The tensor structuring module 110 receives the model's high-precision weight matrices, layer activation configurations, and optional rotation control parameters, and encodes these items into structured, memory-aligned digital formats. These tensors are stored in the memory module 102 and made accessible to downstream modules.

The model initialization module 120 retrieves the structured model tensors and performs internal architecture adjustments. For example, normalization layers are examined and modified to remove floating-point scaling operations, and the scale factors are absorbed into nearby weight matrices to ensure computational invariance under rotation. The initialized model object, now prepared for transformation, is saved to the memory module 102.

The rotation configuration module 130 then accesses the model object and applies orthogonal rotation transformations using generated Hadamard or block-diagonal matrices. Projection weights associated with attention and feed-forward layers are extracted, multiplied with rotation matrices and their transposes to apply between-block rotation, while in-block rotation is applied to intermediate activation tensors at specific points after normalization but before nonlinearities. The result is a rotated model object with suppressed statistical outliers, stored again in the memory module 102.

Next, the rotation-aware fine-tuning module 140 retrieves the rotated model and inserts low-rank adaptation structures according to a selected fine-tuning strategy. For example, under the LAR mode, rank-limited trainable matrices are applied directly to the rotated weights. Under the LBR mode, fine-tuning is performed in the unrotated space and the resulting adapted weights are subsequently rotated. In both cases, SVD is used to initialize low-rank matrices. Fine-tuning is executed using task-specific datasets (e.g., instruction tuning), and only the inserted low-rank components are updated during training. The resulting fine-tuned model object is merged and persisted in the memory module 102.

Once fine-tuning is complete, the quantization module 150 retrieves the model object and performs per-channel symmetric quantization on weights and per-tensor quantization on activations. The quantization strategy (e.g., RTN or GPTQ) is selected based on deployment constraints such as inference latency or hardware target. The output is a memory-resident model object comprising low-bit encoded weight and activation tensors, suitable for inference.

At this stage, the system 100 has generated a complete and executable LLM artifact. This model object is configured for deployment and may be exported or loaded into an inference runtime via the hardware interface module 190. The evaluation and analysis module 160 may optionally be invoked to benchmark the quantized model's performance on curated tasks such as commonsense reasoning or multimodal instruction following. Output metrics such as quantization error and activation distribution kurtosis may be logged for future tuning or audit purposes.

In some embodiments, the system 100 may be integrated into a computing device configured to perform low-bit inference based on a fine-tuned large language model. The computing device comprises at least one processor and one or more non-transitory computer-readable storage media that store executable logic and model artifacts used by the system 100. The system 100 operates on the computing device to perform model structuring, rotation, fine-tuning, and quantization, as described above. The computing device further includes at least one hardware accelerator selected from a GPU, a NPU, or a TPU. Upon completion of quantization, the hardware interface module of the system 100 retrieves the low-bit model representation from the memory module and transmits the model representation to the designated hardware accelerator. This configuration enables the computing device to execute high-efficiency inference tasks using the optimized and quantized large language model produced by the system 100.

As discussed above, the present invention provides RoLoRA, a system designed to enable weight-activation quantization in conjunction with LoRA. RoLoRA introduces rotation to eliminate outliers in activation distributions and incorporates rotation-aware fine-tuning to preserve the outlier-free characteristics throughout training. The integration of rotation into LoRA is supported by both theoretical analysis and empirical evaluation. RoLoRA improves the performance of W4A4 and W6A6 large language models across various tasks without increasing training cost. In addition, RoLoRA demonstrates applicability in visual instruction tuning scenarios.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for fine-tuning a large language model under low-bit weight-activation quantization, comprising:
a memory module configured to store structured representations associated with a model object comprising weight matrices, activation signals, rotation parameters, and intermediate or final representations;
a tensor structuring module configured to receive the structured representations of the model object from the memory module and process the structured representations into structured digital formats suitable for computer processing, wherein the structured digital formats are stored in the memory module;
a model initialization module configured to retrieve the structured digital formats from the memory module and modify internal normalization components of the model object to maintain computational invariance during rotation;
a rotation configuration module configured to retrieve the modified model object from the memory module, apply orthogonal rotation transformations to weight matrices and activation signals of the model object, and store the rotated model object in the memory module;
a rotation-aware fine-tuning module configured to retrieve the rotated model object and apply low-rank adaptation according to a selected fine-tuning strategy to the model object, wherein the low-rank adaptation comprises inserting and training low-rank matrices while keeping base weights frozen;
a quantization module configured to retrieve the fine-tuned model object and perform quantization of both weights and activations using at least one quantization strategy to generate a low-bit model representation stored in the memory module; and
a hardware interface module configured to export the low-bit model representation stored in the memory module to an inference system for deployment.

2. The system of claim 1, wherein the orthogonal rotation transformations comprise at least one of a Hadamard matrix or a block-diagonal matrix applied to attention and feed-forward weight matrices.

3. The system of claim 1, wherein the rotation configuration module is further configured to apply between-block rotation to projection weight matrices and in-block rotation to activation tensors after normalization layers and before nonlinear functions.

4. The system of claim 1, wherein the rotation-aware fine-tuning module is further configured to operate in a LoRA After Rotation (LAR) mode by inserting low-rank matrices after rotation and training the low-rank matrices in the rotated weight space.

5. The system of claim 1, wherein the rotation-aware fine-tuning module is further configured to operate in a LoRA Before Rotation (LBR) mode by applying low-rank adaptation before rotation and subsequently transforming the adapted weights via rotation.

6. The system of claim 1, wherein the quantization module is further configured to perform per-channel symmetric quantization on weights and per-tensor quantization on activations.

7. The system of claim 1, further comprising:
an evaluation and analysis module configured to retrieve the low-bit model representation and compute evaluation metrics with activation kurtosis and quantization error.

8. The system of claim 1, further comprising:
a digital transformation interface module configured to convert floating-point tensors, rotation matrices, and low-rank vectors into memory-aligned digital formats compatible with hardware execution.

9. The system of claim 1, further comprising:
a compatibility interface module configured to adapt the system for LoRA variants by re-integrating decomposed directional and magnitude weight components into the fine-tuning process.

10. The system of claim 1, wherein the memory module comprises one or more non-transitory computer-readable storage media selected from the group consisting of dynamic random-access memory (DRAM), static RAM (SRAM), flash memory, and solid-state drives (SSD).

11. A computing device, comprising:
at least one processor;
one or more non-transitory computer-readable storage media;
the system according to claim 1 for fine-tuning a large language model under low-bit weight-activation quantization; and
a graphics processing unit (GPU), a neural processing unit (NPU), or a tensor processing unit (TPU);
wherein the hardware interface module of the system is configured to load a low-bit model representation from the memory module and transmit the model representation to the GPU, NPU, or TPU for inference execution.

12. A method for fine-tuning a large language model under low-bit weight-activation quantization, comprising:
receiving, by a tensor structuring module, structured representations associated with a model object comprising weight matrices, activation signals, and rotation parameters;
processing the structured representations into structured digital formats suitable for computer processing, by the tensor structuring module, and storing the structured digital formats in a memory module;
modifying, by a model initialization module, internal normalization components of the model object to maintain computational invariance during rotation;
applying, by a rotation configuration module, orthogonal rotation transformations to weight matrices and activation signals of the model object to produce a rotated model object;
applying, by a rotation-aware fine-tuning module, low-rank adaptation to the rotated model object according to a selected fine-tuning strategy, wherein the low-rank adaptation comprises inserting and training low-rank matrices while keeping base weights frozen;
performing, by a quantization module, quantization of both weights and activations using at least one quantization strategy to generate a low-bit model representation; and
exporting, by a hardware interface module, the low-bit model representation to an inference system for deployment.

13. The method of claim 12, wherein the applying orthogonal rotation transformations comprises applying at least one of a Hadamard matrix or a block-diagonal matrix to attention and feed-forward weight matrices.

14. The method of claim 12, wherein the applying orthogonal rotation transformations comprises:
applying between-block rotation to projection weight matrices; and
applying in-block rotation to activation tensors after normalization layers and before nonlinear functions.

15. The method of claim 12, wherein the applying low-rank adaptation comprises operating in a LoRA After Rotation (LAR) mode by inserting low-rank matrices after rotation and training the low-rank matrices in the rotated weight space.

16. The method of claim 12, wherein the applying low-rank adaptation comprises operating in a LoRA Before Rotation (LBR) mode by applying low-rank adaptation before rotation and subsequently transforming the adapted weights via rotation.

17. The method of claim 12, wherein the performing quantization comprises:
performing per-channel symmetric quantization on weights; and
performing per-tensor quantization on activations.

18. The method of claim 12, further comprising:
evaluating the low-bit model representation using benchmark tasks and computing evaluation metrics comprising activation kurtosis and quantization error.

19. The method of claim 12, further comprising:
converting floating-point tensors, rotation matrices, and low-rank vectors into memory-aligned digital formats compatible with hardware execution.

20. The method of claim 12, further comprising:
adapting the model object for a LoRA variant by re-integrating decomposed directional and magnitude weight components into the fine-tuning process.
